(19) United States
(12) Patent Application Publication
(10) Pub. No.: US 2013/0339620 A1
(43) Pub. Date: Dec. 19, 2013

(54) Providing Cache Replacement Notice Using a Cache Miss Request

(71) Applicant: FUTUREWEI TECHNOLOGIES, INC., Plano, TX (US)

(72) Inventor: Iulin Lih, San Jose, CA (US)

(73) Assignee: Futurewei Technololgies, Inc., Plano, TX (US)

(21) Appl. No.: 13/868,281

(22) Filed: Apr. 23, 2013

Related U.S. Application Data
(60) Provisional application No. 61/660,086, filed on Jun. 15, 2012.

(51) Int. Cl. G06F 12/08

(52) U.S. Cl. CPC G06F 12/0817
USPC 711/133

(57) ABSTRACT

A computing device has an interface and a processor. The interface is configured to receive a cache miss request from a cache memory, and the processor is configured to identify data that is being removed from the cache memory based at least in part on information obtained from the cache miss request. In another embodiment, a computing device has a memory, a first interface, a processor, and a second interface. The processor is configured to generate a cache miss request when it is determined that data identified in a cache request received through the first interface is not stored in the memory, and the second interface is configured to send the cache miss request to a cache memory. The cache miss request optionally includes an indication of the data identified in the cache request and an indication of a portion of the cached data that is being removed from the memory.

### CROSS-REFERENCE TO RELATED APPLICATION

The present application claims priority to U.S. Provisional Patent Application No. 61/660,086 filed Jun. 15, 2012 by Yolin Lih and entitled “A Method for Cache Replacement Notice,” which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A computing system may use a cache memory to improve computing performance. For instance, a computing system may store data that it needs to access more frequently in a smaller, faster cache memory instead of storing the data in a slower, larger memory (e.g., a main memory unit). Accordingly, the computing system is able to access the data quicker, which can reduce the latency of memory accesses. Additionally, some computing systems may include multiple levels of cache memory to further improve performance.

In a computing system having multiple levels of cache memory, the computing system first attempts to read or write data from a lower-level cache memory. If the data is not in the lower-level cache memory, the lower-level cache memory will send a cache miss request to the next higher-level cache memory to obtain the data. The higher-level cache memory will either fulfill the cache miss request using data from its own memory or will obtain the data from an even higher-level cache memory or the main memory and then fulfill the cache miss request.

Sometimes when a cache memory needs to store new data, it will have open memory space available to accommodate the new data. However, the cache memory will often not have open memory space available and will need to create space by removing previously stored data from the memory. When this occurs, the cache memory sends the next higher-level cache memory a cache replacement notice message. The cache replacement notice message may include the full line address of the data being removed and additional information such as, but not limited to, source and/or destination information, error correction information, etc. The higher-level cache memory uses the cache replacement notice message to update its directory information such that the higher-level cache memory knows what data is stored in the lower-level cache memory.

### SUMMARY

In one embodiment, the disclosure includes a computing device having an interface and a processor. The interface is configured to receive a cache miss request from a cache memory. The processor is coupled to the interface and is configured to identify data that is being removed from the cache memory based at least in part on information obtained from the cache miss request.

In another embodiment, the disclosure includes a computing device having a memory, a first interface, a processor, and a second interface. The memory is configured to store cached data. The first interface is configured to receive a cache request. The processor is coupled to the first interface and is configured to generate a cache miss request when it is determined that the data identified in the cache request is not stored in the memory. The second interface is coupled to the processor and is configured to send the cache miss request to a cache memory. The cache miss request optionally includes an indication of the data identified in the cache request and an indication of a portion of the cached data that is being removed from the memory.

In yet another embodiment, the disclosure includes a method for providing a cache replacement notice. Directory information about data stored in a cache memory is stored, and a cache miss request is received from the cache memory. The directory information is updated based at least in part on information included in the cache miss request.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a computing environment that uses a cache miss request to provide a cache replacement notice.

FIG. 2 is a flowchart of a method for using a cache miss request to provide a cache replacement notice from the perspective of a lower-level cache memory.

FIG. 3 is a flowchart of a method for using a cache miss request to provide a cache replacement notice from the perspective of a higher-level cache memory.

FIG. 4 is a schematic diagram of an associative cache mapping scheme.

FIG. 5 is a schematic diagram of a direct cache mapping scheme.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents. While certain aspects of conventional technologies have been discussed to facilitate the present disclosure, applicants in no way disclaim these technical aspects, and it is contemplated that the present disclosure may encompass one or more of the conventional technical aspects discussed herein.

Embodiments of the present disclosure include methods and apparatuses for providing a cache replacement notice using a cache miss request. In certain instances, cache replacement notice information (e.g., a cache replacement attribute) is appended to a cache miss request, and only the one request is sent to a higher-level cache memory instead of separately sending both a cache replacement notice and a cache miss request. For example, if a lower-level cache memory is full and it receives a request for data that it does not have, the lower-level cache memory will send the higher-level cache memory a cache miss request with appended cache replacement notice information. The higher-level cache memory can use the cache miss request to both identify the data that needs to be sent to the lower-level cache memory and to identify the data that is going to be removed from the lower-level cache memory. Accordingly, the lower-level cache memory does not need to send, and the higher-level cache memory does not need to receive, both a cache replacement notice and a cache miss request. This can be useful in reducing the number of messages exchanged between the lower-level and the higher-level cache memories. This can also be useful in reducing bandwidth requirements, message latency, outgoing bandwidth pollution, queue space pollution, and blocking latency pollution. Further features and benefits of embodiments are described below and shown in the accompanying figures.

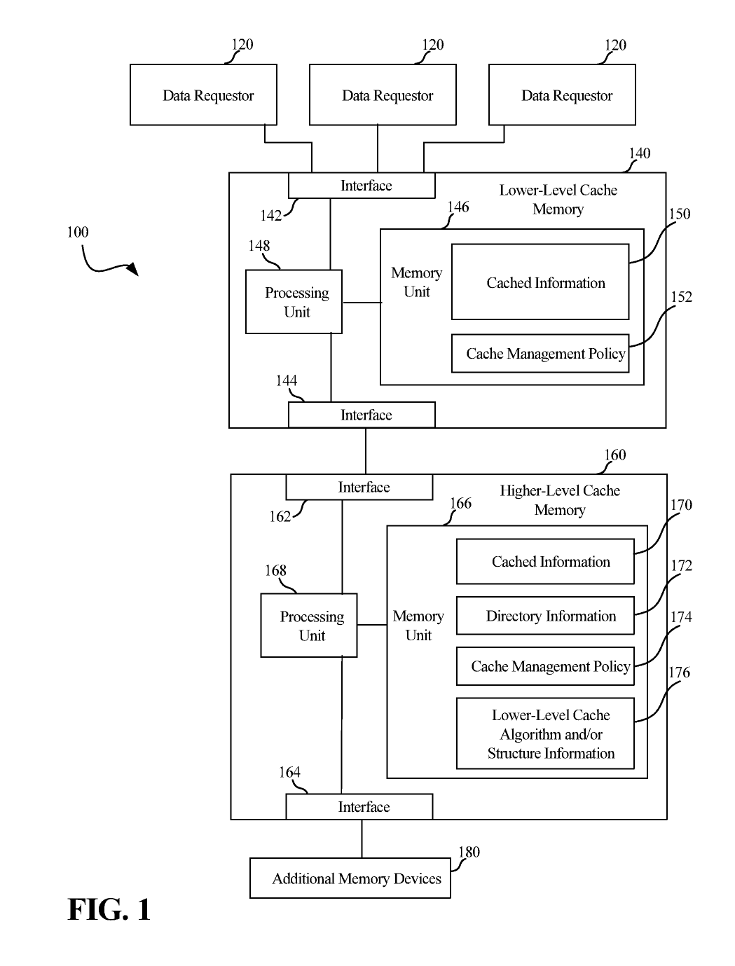

FIG. 1 is a schematic diagram of a computing environment 100 that uses a cache miss request to provide a cache replacement notice. Embodiments are not however limited to any particular environment and can be practiced in environments that are different than the specific example shown in FIG. 1.

Computing environment 100 comprises one or more data requestors 120, a lower-level cache memory 140, a higher-level cache memory 160, and additional memory devices 180. Data requestors 120 can include any type or combinations of different types of computing devices that may need to use a cache memory. For instance, data requestors 120 can include a stand-alone computing device such as, but not limited to, a personal computer, a laptop computer, a tablet, a smartphone, a server, etc. Data requestors 120 can also include a component of a larger computing device such as, but not limited to, a central processing unit or a core of a multi-core central processing unit.

Lower-level cache memory 140 and higher-level cache memory 160 can comprise any type or combination of types of memory storage devices. For instance, lower-level cache memory 140 and higher-level cache memory 160 can include integrated on-chip cache memory (e.g., level 1, level 2, level 3, etc. cache memories integrated within a same die as a processor), separate computer chips, magnetic storage devices, optical storage devices, or any other types of memory storage devices.

Lower-level cache memory 140 optionally comprises a first communication interface 142, a second communication interface 144, a memory unit 146, and a processing unit 148. First communication interface 142 is used by lower-level cache memory 140 to send data to and receive data from data requestors 120. For instance, lower-level cache memory 140 can receive a cache request through interface 142 from one of the data requestors 120, and the lower-level cache memory 140 can send a response to the request (e.g., a response that includes the requested data) back to the data requestor 120 through interface 142.

Second communication interface 144 is used by lower-level cache memory 140 to send data to and receive data from higher-level cache memory 160. For instance, if lower-level cache memory 140 does not have the data required to fulfill a cache request from one of the requestors 120, lower-level cache memory 140 can send a cache miss request to higher-level cache memory 160 through interface 144. Lower-level cache memory 140 could then receive the response to the cache miss request from higher-level cache memory 160 through interface 144. Also, it should be noted that the lower-level cache memory first communication interface 142, the lower-level cache memory second communication interface 144, and the other communication interfaces described in this application can be implemented using any type or combination of types of communication interfaces. For example, each communication interface can be implemented using one or more ports (e.g., ports 1-N, where N is equal to any number) or any other type of communication interface.

Memory unit 146 may include cached information 150 and a cache management policy 152. In one embodiment, cached information 150 includes data from a main memory unit, and the data is stored in cached information 150 as cache lines. Each cache line includes a data block that includes data from the main memory unit, a tag that includes the address of the data in the main memory unit, and one or more status bits. The status bits can be used to indicate a particular status of the cache line. For instance, a cache line can be marked as being clean or dirty. When a cache line is clean, the data in the data block has not been changed since it was read from the main memory unit. When a cache line is dirty, the data in the data block has been changed since it was read from the main memory unit.

Cache management policy 152 can include any data, instructions, algorithms, etc. needed to manage the operations of lower-level cache memory 140. In one embodiment, cache management policy 152 includes a replacement policy and a write policy. The replacement policy provides instructions on how the lower-level cache memory 140 will decide what cached information 150 should be removed or evicted when the lower-level cache memory 140 needs to make space available for new data. Some examples of replacement policies that could be used include a first-in first-out (FIFO) replacement policy and a least-recently used (LRU) replacement policy. The write policy provides instructions on how the lower-level cache memory 140 will write information from its cached information 150 to the main memory unit. Some examples of write policies include a write-through policy and a write-back policy. Embodiments are not however limited to any particular type of cache management policies, replacement policies, and write policies, and embodiments can use any cache management policies, replacement policies, and write policies.

Processing unit 148 optionally performs any processing, logic operations, computations, etc. that are needed to operate lower-level cache memory 140. For instance, processing unit 148 can receive data from interface 142, interface 144, and/or memory unit 146, process the data according to instructions stored in memory unit 146 (e.g., instructions stored in the cache management policy 152), and provide a result as an output.

Higher-level cache memory 160 optionally comprises a first communication interface 162, a second communication interface 164, a memory unit 166, and a processing unit 168. First communication interface 162 is used by higher-level cache memory 160 to send data to and receive data from lower-level cache memory 140. For instance, higher-level cache memory 160 can receive a cache miss request from lower-level cache memory 140 through interface 162 and can respond to the cache miss request (e.g., by sending the requested data) to lower-level cache memory 140 through interface 162.

Second communication interface 164 is used by higher-level cache memory 160 to send data to and receive data from additional memory devices 180. Additional memory devices 180 can include any type or combinations of types of memory devices that are communicatively coupled to higher-level cache memory 160. For example, additional memory devices 180 may include an even higher-level cache memory (e.g., a level 3 cache, a level 4 cache, etc.), a main memory unit, a magnetic storage device, an optical storage device, a stand-alone computing device, etc. Higher-level cache memory 160 can use second communication interface 164 to send cache miss requests to additional memory devices 180, to write-back data, or perform any other needed data exchanges with additional memory devices 180.

Memory unit 166 may include cached information 170, directory information 172, a cache management policy 174, and lower-level cache algorithm and/or structure information 176. Cached information 170 can include data from a main memory unit. Similar to cached information 150 in the lower-level cache memory 140, cached information 170 can include data that is stored as cache lines having data blocks, tags, and one or more status bits. In an embodiment, higher-level cache memory 160 may have a larger amount of memory available for cached information 170 than lower-level cache memory 140 has for cached information 150. Accordingly, higher-level cache memory 160 is able to provide data to lower-level cache memory 140 that memory 140 does not have the capacity to store. Additionally, higher-level cache memory 160 may have slower read and/or write times than lower-level cache memory 140. Embodiments are not however limited to any particular configuration of sizes and/or relative speeds, and both the lower-level cache memory 140 and the higher-level cache memory 160 can have any capacity sizes and/or speeds.

Directory information 172 optionally stores information about what data (e.g., what main memory data, what tags, etc.) is stored in lower-level cache memory 140. In an embodiment, when higher-level cache memory 160 receives a cache miss request from lower-level cache memory 140, the cache miss request includes cache replacement notice information included with it (e.g., a cache replacement attribute). Higher-level cache memory 160 is able to use the cache replacement notice information in the cache miss request to update directory information 172 such that higher-level cache memory 160 is able to keep up-to-date about the contents of lower-level cache memory 140 without receiving a separate cache replacement notice message.

Cache management policy 174 may include cache management policy information similar to the cache management policy 152 in lower-level cache memory 140. For instance, cache management policy 174 can include any data, instructions, algorithms, etc. needed to manage the operations of higher-level cache memory 160 such as, but not limited to, a replacement policy and a write policy. Higher-level cache memory 160's policies could be the same or similar to those of lower-level cache memory 140. However, cache management policy 174 is not limited to any particular type of cache management policies, replacement policies, and write policies, and embodiments can use any cache management policies, replacement policies, and write policies.

Lower-level cache algorithm and/or structure information 176 may include information about the algorithms used by lower-level cache memory 140 (e.g., information about the cache management policy 152) and/or information about the structure and organization of lower-level cache memory 140. For instance, the information about the structure and organization of lower-level cache memory 140 could include information about an associativity scheme used by lower-level cache memory 140 (e.g., N-way associative, direct-mapped, speculative execution, skewed associative, pseudo-associative, etc.). In some embodiments, higher-level cache memory 160 can use the information in its lower-level cache algorithm and/or structure information 176 by itself or in combination with information from a cache miss request to update its directory information 172. For example, if lower-level cache memory 140 uses a direct-mapping scheme, then each piece of data (e.g., each cache line) can only be stored to one location in lower-level cache memory 140. Accordingly, higher-level cache memory 160 does not need any cache replacement notice information from lower-level cache memory 140 to determine where any newly requested data will be stored. The newly requested data can only be stored to one location. Therefore, higher-level cache memory 160 will know that the data previously stored at that location is being evicted and is being replaced with the newly requested data. Higher-level cache memory 160 can then update its directory information 172 accordingly. In another example, lower-level cache memory 140 uses an N-way associative mapping, and higher-level cache memory 160 stores an indication of the N-way associative mapping in its information 176. In such a case, the lower-level cache memory 140 may include an indication of which one of the N ways has the data that is being evicted. Then, based on what data was requested in the cache miss request, which way was identified in the cache miss request, and the directory information 172, higher-level cache memory 160 is able to determine what data is being evicted and where the newly requested data is going to be stored. In light of the above, it should be highlighted that in at least certain embodiments that higher-level cache memory 160 is able to update its directory information 172 without receiving any information about which lower-level cache data is being evicted or is able to update its directory information 172 with receiving only partial information (e.g., a way identifier) of what cache data is being evicted. Accordingly, at least some embodiments are able to eliminate the need for using separate cache replacement notice messages to update higher-level cache memory 160's directory information 172.

Finally with respect to FIG. 1, higher-level cache memory 160's processing unit 168 optionally performs any processing, logic operations, computations, etc. that are needed to operate higher-level cache memory 160. For instance, processing unit 168 can receive data from interface 162, interface 164, and/or memory unit 166, process the data according to instructions stored in memory unit 166, and provide a result as an output. In one example, higher-level cache memory 160 uses its processing unit 168 to determine what cache is being evicted from lower-level cache memory 140 and uses that information to update the directory information 172 in its memory 166.

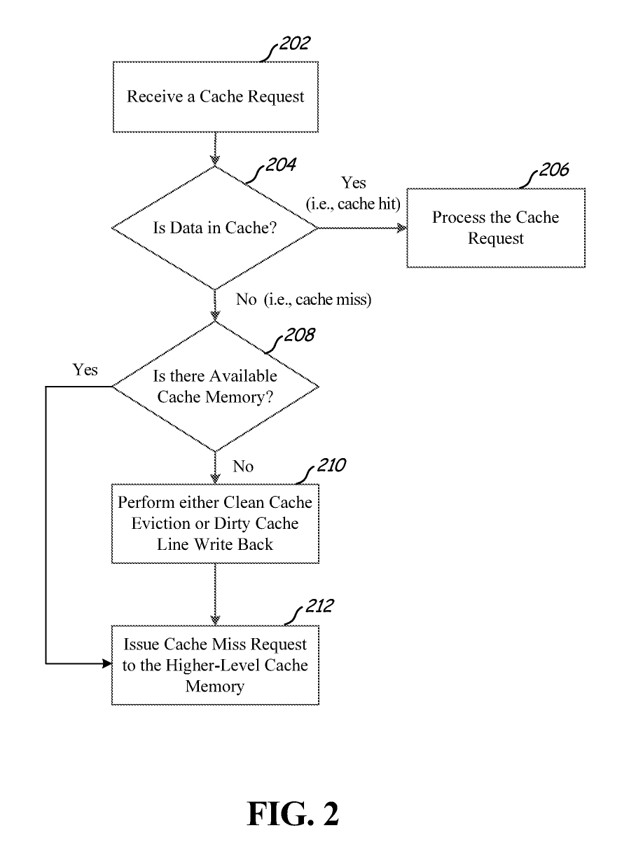

FIG. 2 is a flowchart of a method for using a cache miss request to provide a cache replacement notice from the perspective of a lower-level cache memory. At block 202, a cache request is received. For instance, in an embodiment in which the lower-level cache memory is a level 1 cache, the level 1 cache can receive a cache request from, e.g., a central processing unit or a core of a central processing unit. At block 204, a determination is made as to whether the data identified in the cache request is included in the lower-level cache memory. If the data is in the lower-level cache memory, then there is a cache hit, and the method continues to block 206 where the lower-level cache memory processes the cache request (e.g., reads or writes the data as specified by the cache request). If the data is not in the lower-level cache memory, then there is a cache miss, and the method continues to block 208 where a determination is made as to whether there is any available cache memory (e.g., cache memory that does not already have data in it). If there is available cache memory, the method continues to block 212 where the lower-level cache memory issues a cache miss request to the higher-level cache memory. The cache miss request includes an indication of the data specified by the cache request. The cache miss request may also include an indication of the available cache memory location that was identified at block 208. This can be used by the higher-level cache memory to update its directory information as to where the newly requested data will be stored.

If there is not available cache memory at block 208, then the lower-level cache memory needs to make some memory available for the newly requested data. The lower-level cache memory accomplishes this by either performing a clean cache eviction or a dirty cache line write-back at block 210. After the lower-level cache memory has made some memory space available for the newly requested data, the method continues to block 212 where the lower-level cache memory issues a cache miss request to the higher-level cache memory. In one embodiment, the cache miss request does not include any indication of where in the lower-level cache memory that the newly requested data will be stored. For instance, in the case where the lower-level cache memory uses a direct mapping scheme, the higher-level cache memory is able to determine where the lower-level cache memory will store the newly requested data based on what data is being requested and based on information that the higher-level cache memory stores about the lower-level cache memory (e.g., information about algorithms, policies, structures, etc. implemented by the lower-level cache memory). In another embodiment, the cache miss request does include an indication of where in the lower-level cache memory that the newly requested data will be stored. The indication of where in the lower-level cache memory that the newly requested data will be stored may include only a small amount of data. For instance, if the lower-level cache memory uses an N-way associative mapping scheme, the indication may include a way identifier of which one of the N ways where the newly requested data will be stored. For example, if the lower-level cache memory uses a 4-way associative mapping scheme, the cache miss request may include a way identifier such as way-1, way-2, way-3, or way-4. Accordingly, the cache miss request may include no information identifying where the requested data will be stored or may only include partial information of where the requested data will be stored. The higher-level cache memory will still be able to determine where the data is going to be stored based on the requested data and based on its stored information about the lower-level cache memory. However, in yet another embodiment, the cache miss request may include the full address or location information of where the newly requested data will be stored. This embodiment may still be beneficial over other systems that send the cache miss request and the cache replacement notice in separate messages by reducing the number of messages exchanged between the lower-level and the higher-level cache memories and reducing the latency between the messages.

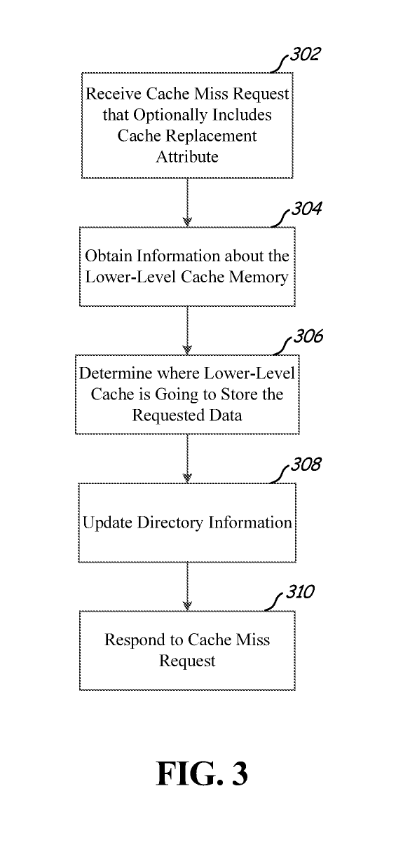

FIG. 3 is a flowchart of a method for using a cache miss request to provide a cache replacement notice from the perspective of a higher-level cache memory. At block 302, the higher-level cache memory receives a cache miss request from a lower-level cache memory. As discussed above, the cache miss request includes an indication of what data is being requested. The cache miss request may include no indication of where the data is going to be stored by the lower-level cache memory, a partial indication of where the data is going to be stored by the lower-level cache memory (e.g., a way identifier or other cache replacement attribute), or may include a full indication of where the data is going to be stored by the lower-level cache memory. At block 304, the higher-level cache memory obtains information about the lower-level cache memory (e.g., policy information, algorithm information, structure information, organization scheme, etc.). This information could be stored and retrieved locally within the higher-level cache memory such as is shown in FIG. 1, or the information could be obtained from a remote source. At block 306, the higher-level cache memory determines the location of where the data is going to be stored by the lower-level cache memory. In the case where the cache miss request includes no indication of where the data is going to be stored, the higher-level cache memory determines the location based solely on the indication of what data is being requested at block 302 and based on the information about the lower-level cache memory obtained at block 304. In the case where the cache miss request includes partial information about where the data is going to be stored (e.g., a way identifier or other cache replacement attribute), the higher-level cache memory determines the location based on the partial location information in the cache miss request, based on what data is being requested in the cache miss request, and based on the lower-level cache memory information obtained at block 304. In the case where the cache miss request includes the full information about where the data is going to be stored (e.g., a full memory location address), the higher-level cache memory can optionally skip block 304 and determine the location where the data is going to be stored based solely on the information in the cache miss request.

At block 308, the higher-level cache memory updates its directory information about what data is stored in the lower-level cache memory. For instance, if the directory information indicates that there is any other data previously stored at the location determined at block 306, the higher-level cache memory can determine that the data previously stored at the location is being removed from the lower-level cache memory and is being replaced with the newly requested data. Accordingly, the higher-level cache memory updates its directory information to indicate that the previously stored data is no longer in the lower-level cache memory and that the newly requested data is in the lower-level cache memory.

At block 310, the higher-level cache memory responds to the cache miss request. If the higher-level cache memory has the requested data stored locally, it can send the data directly to the lower-level cache memory. If the higher-level cache memory does not have the requested data stored locally, it can request and obtain the data from another memory device. For instance, the higher-level cache memory can request the data from an even higher-level cache memory (e.g., a level 3, level 4, etc. cache memory), a main memory unit, or any other memory device.

It should be noted that the sequence of steps described above and shown in FIG. 3 are given merely for illustration purposes only. Embodiments of the present disclosure are not limited to any particular order of completing the steps. In other embodiments, the illustrated steps may be performed in a different sequence and/or some steps may be performed in parallel. Additionally, embodiments can include methods and devices that omit or add one or more steps as compared to the particular example shown in FIG. 3.

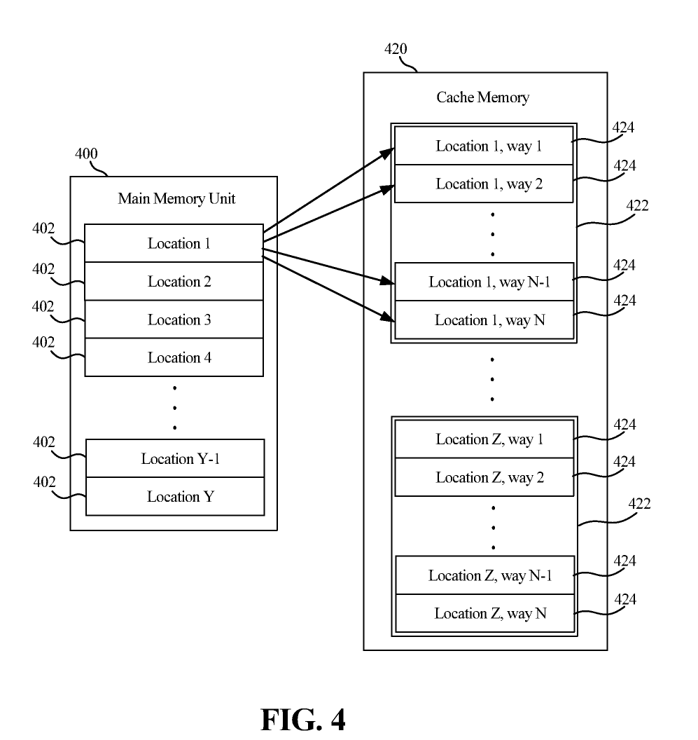

FIG. 4 is a schematic diagram of an N-way associative cache mapping scheme. Certain embodiments of the disclosure may be utilized with cache memories that use an N-way associative cache mapping scheme. In FIG. 4, main memory unit 400 includes memory locations 402, and cache memory 420 includes memory locations 422. Main memory unit 400 and cache memory 420 may include any number of locations. For example, main memory unit 400 can include memory locations 1 through Y, where Y is any number, and cache memory 420 can include memory locations 1 through Z, where Z is any number. Each location 422 within cache memory 420 includes a number of ways 424. Ways 424 can include ways 1 through N, where N is any number (e.g., 2, 3, 4, 5, 6, 7, 8, etc.). Additionally, each way 424 can be identified by a way identifier (e.g., way-1, way-2, etc.).

In an embodiment, each main memory unit location 402 can be stored to multiple cache memory unit ways 424. The particular mapping scheme used by a lower-level cache memory can be stored by a higher-level cache memory. Accordingly, a higher-level cache memory can determine where the lower-level cache memory is going to store data if the lower-level cache memory provides an indication of which way that the lower-level cache memory is going to use. Thus, by storing information about the mapping scheme used by the lower-level cache memory, the higher-level cache memory does not need to receive full address information from the lower-level cache memory to determine where the lower-level cache memory is going to store data.

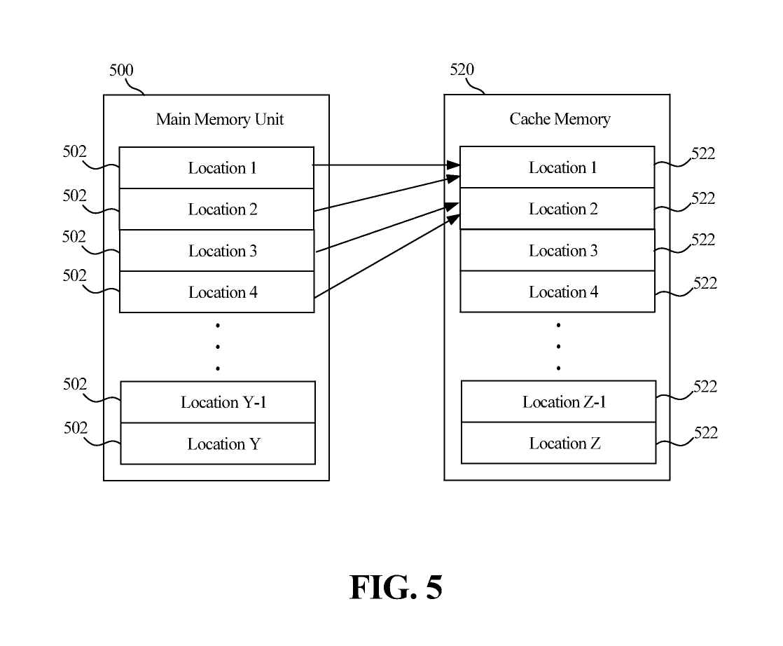

FIG. 5 is a schematic diagram of a direct cache mapping scheme. Certain embodiments of the disclosure may be utilized with cache memories that use direct cache mapping schemes. In FIG. 5, main memory unit 500 includes memory locations 502, and cache memory 520 includes memory locations 522. Main memory unit 500 and cache memory 520 may include any number of locations. For example, main memory unit 500 can include memory locations 1 through Y, where Y is any number, and cache memory 520 can include memory locations 1 through Z, where Z is any number.

In an embodiment, each main memory unit location 502 can only be stored to one cache memory location 522. Accordingly, a higher-level cache memory can determine where the lower-level cache memory is going to store data based solely on the identity of the data being stored. Thus, in a direct cache mapping scheme, the higher-level cache memory does not need to receive any extra information from the lower-level cache memory to determine where data is going to be stored as long as the higher-level cache memory is able to obtain information about the particular mapping scheme used by the lower-level cache memory.

As previously mentioned, embodiments of the present disclosure may use an N-way associative mapping scheme such as the one shown in FIG. 4 or a direct mapping scheme such as the one shown in FIG. 5. Embodiments may also use any other mapping scheme such as, but not limited to, speculative execution, skewed associative, pseudo-associative, etc. Therefore, embodiments are not limited to any particular mapping scheme used by a cache memory, and embodiments can be adapted to be used with a wide variety of cache memories.

As described above and shown in the figures, embodiments include methods and apparatuses for providing a cache replacement notice using a cache miss request. In certain instances, cache replacement notice information (e.g., a cache replacement attribute) is appended to a cache miss request, and only the one request is sent to a higher-level cache memory instead of separately sending both a cache replacement notice and a cache miss request. The higher-level cache memory can use the cache miss request to both identify the data that needs to be sent to the lower-level cache memory and to identify the data that is going to be removed from the lower-level cache memory. In other instances, only partial cache replacement notice information or no cache replacement notice information is appended to a cache miss request. In such a case, the higher-level cache memory is still able to identify the data that is going to be removed from the lower-level cache memory by obtaining information about policies, algorithms, structures, mapping schemes, etc. used by the lower-level cache memory. Accordingly, the lower-level cache memory does not need to send, and the higher-level cache memory does not need to receive, both a cache replacement notice and a cache miss request.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term about means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A computing device comprising:
an interface configured to receive a cache miss request from a cache memory; and
a processor coupled to the interface and configured to identify data that is being removed from the cache memory based at least in part on information obtained from the cache miss request.

2. The computing device of claim 1, wherein the cache miss request comprises a replacement attribute, and wherein the processor is configured to identify the data that is being removed based at least in part on the replacement attribute.

3. The computing device of claim 2, wherein the replacement attribute comprises a way identifier.

4. The computing device of claim 2, wherein the replacement attribute comprises at least a portion of a memory address.

5. The computing device of claim 1, wherein the cache miss request comprises an indication of data being requested by the cache memory, and wherein the processor is configured to identify the data that is being removed based at least in part on the indication of the data being requested.

6. The computing device of claim 1, further comprising a memory that is configured to store information about a mapping scheme used by the cache memory, and wherein the processor is configured to identify the data that is being removed based at least in part on the information about the mapping scheme.

7. The computing device of claim 1, further comprising a memory that is configured to store information about a cache management policy used by the cache memory, and wherein the processor is configured to identify the data that is being removed based at least in part on the information about the cache management policy.

8. The computing device of claim 1, further comprising a memory that is configured to store directory information about data stored in the cache memory, and wherein the processor is configured to update the directory information stored in the memory based at least in part on the identity of the data being removed from the cache memory.

9. The computing device of claim 1, wherein the computing device comprises a higher-level cache memory, and wherein the cache memory comprises a lower-level cache memory.

10. A computing device comprising:
a memory configured to store cached data;
a first interface configured to receive a cache request;
a processor coupled to the first interface and configured to generate a cache miss request when it is determined that data identified in the cache request is not stored in the memory; and
a second interface coupled to the processor and configured to send the cache miss request to a cache memory, wherein the cache miss request includes an indication of the data identified in the cache request and an indication of a portion of the cached data that is being removed from the memory.

11. The computing device of claim 10, wherein the indication of the portion of the cached data that is being removed from the memory comprises a cache replacement attribute.

12. The computing device of claim 10, wherein the indication of the portion of the cached data that is being removed from the memory comprises an address associated with the cached data that is being removed.

13. The computing device of claim 10, wherein the indication of the portion of the cached data that is being removed from the memory comprises a way identifier.

14. The computing device of claim 10, wherein the memory is configured to store the cached data using an associative mapping scheme.

15. The computing device of claim 10, wherein the memory is configured to store the cached data using a direct mapping scheme.

16. A method comprising:
storing directory information about data stored in a cache memory;
receiving a cache miss request from the cache memory; and
updating the directory information based at least in part on information included in the cache miss request.

17. The method of claim 16, further comprising identifying a portion of the data stored in the cache memory that is being removed based at least in part on the information included in the cache miss request.

18. The method of claim 16, further comprising identifying a portion of the data stored in the cache memory that is being removed based at least in part on stored information about the cache memory.

19. The method of claim 16, further comprising identifying a portion of the data stored in the cache memory that is being removed based at least in part on the information included in the cache miss request and stored information about the cache memory.

20. The method of claim 16, wherein receiving the cache miss request comprises receiving an indication of data being requested and a cache replacement attribute.
